(19) United States
(12) Patent Application Publication
(10) Pub. No.: US 2010/0270246 A1
(43) Pub. Date: Oct. 28, 2010

(54) DOOR-SUPPORTED STORAGE DEVICE

(76) Inventor: David Robert Rodriguez, Ada, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/766,287

(22) Filed: Apr. 23, 2010

Related U.S. Application Data
(60) Provisional application No. 61/172,334, filed on Apr. 24, 2009.
(60) Provisional application No. 61/174,105, filed on Apr. 30, 2009.

(51) Int. Cl. A47G 29/00; A47B 96/00; A47B 81/00; F16M 13/00

(52) U.S. Cl. 211/34; 211/119.004; 211/45; 211/60.1; 248/201

(57) ABSTRACT

A door-supported storage device provides stable and readily reconfigurable storage units along a door or other substantially vertical surface to which rails may be mounted. The rails may be of an aesthetically pleasing design, in which coupling or mounting features are substantially hidden from view. Optionally, the rails are multi-piece rails. By positioning brackets at both upper and lower end portions of the rails, the rails are stably supported at the door, even during opening and closing of the door. Storage units adapted for mounting to the rails may include, for example, a paper-storage shelf, a hanger support, a basket shelf, a storage shelf for loose articles, a rolled paper retainer, a slanted storage shelf, a closable storage bin, a shoe rack, and a storage bin having at least one wall made up of a plurality of elastic cords.

### CROSS REFERENCE TO RELATED APPLICATIONS

The present application claims the benefit of U.S. provisional application, Ser. No. 61/172,334, filed Apr. 24, 2009, and of U.S. provisional application, Ser. No, 61/174,105, filed Apr. 30, 2009, which are hereby incorporated herein by reference in their entireties.

### FIELD OF THE INVENTION

The present invention relates to storage devices and, more particularly, to storage devices mounted to doors in buildings.

### BACKGROUND OF THE INVENTION

Door-mounted storage units can be used to increase the available storage space in a part of a building such as, for example, in a pantry, closet, utility room, or anywhere it may be desirable to provide easily-accessible storage space for small articles.

### SUMMARY OF THE INVENTION

The present invention provides a door-supported storage device that securely mounts to a door without damaging or marring the surfaces of the door, while being securely mounted thereto, and providing modular storage spaces that are repositionable along the door in order to optimize the storage device for a desired purpose. Different types of storage units are mountable and repositionable along rails on the door so that a user may select the desired type(s) of storage unit(s), and position the storage units to optimize their functionality for that user. As needs change, the removable storage units may be removed, repositioned, or replaced with different types of storage units to adapt the storage device to the user's needs.

According to one form of the present invention, the storage device includes a vertical rail and upper and lower brackets for holding the rail to a door. The vertical rail is connected to the door by the upper and lower brackets, with the upper bracket coupled to an upper end portion of the vertical rail and engaging at least an upper edge of the door, and the lower bracket coupled to a lower end portion of the vertical rail and engaging at least a portion of a lower edge of the door. The vertical rail may define an inner channel along its length, the inner channel receiving an inner rail that defines a plurality of slots along its length. One or more accessories are provided for storing articles, and are repositionably mounted at one of a plurality of available positions along the vertical rail, the accessories including engaging members for releasably engaging the slots of the inner rail. Optionally, a pair of horizontally-spaced vertical rails is provided, where each accessory includes spaced engaging members for coupling the accessory to each of the vertical rails.

According to one aspect, the accessory is a paper storage shelf or bin, a multi-purpose hanger support, a basket shelf, a storage shelf or bin for loose articles, or a storage bin having at least one wall made up of a plurality of elastic cords for storing and accessing loose articles substantially anywhere in the bin.

According to another aspect, the upper and lower brackets extend entirely across the upper and lower edges of the door, respectively, and include distal end portions that engage a side of the door opposite the side on which the vertical rail or rails are mounted.

According to still another aspect, the upper and lower brackets each include a generally C-shaped portion for receiving and coupling to a respective end portion of the vertical rail. A fastener is provided at each of the C-shaped portions of the brackets for coupling the C-shaped portions of the upper and lower brackets to the upper end portion and lower end portion of the vertical rail, respectively.

According to another form of the present invention, a storage device for mounting on a door includes a multi-piece vertical rail, upper and lower brackets, a rail coupler assembly, and at least one accessory for supporting articles. The multi-piece vertical rail includes at least an upper rail portion with an upper end portion, and a lower rail portion with a lower end portion. The upper and lower rail portions are arranged end-to-end to form the multi-piece vertical rail, and each of the upper and lower rail portions define an inner longitudinal channel and a plurality of slots for engagement by the one or more accessories. The upper bracket is coupled to the upper rail portion at the upper end portion thereof, and the upper bracket includes a door-engaging portion for extending at least partially over and across an upper edge of the door to hold the upper rail portion against or adjacent the door. Similarly, the lower bracket is coupled to the lower rail portion at the lower end portion thereof, and the lower bracket includes a door-engaging portion for extending at least partially over and across an lower edge of the door to hold the lower rail portion against or adjacent the door. The rail coupler assembly engages the upper and lower rail portions to join the rail portions together. The accessory is mountable and repositionable at a plurality of positions along the multi-piece vertical rail and includes an engaging member for releasably engaging the multi-piece vertical rail at the slots.

According to one aspect, the rail coupler assembly includes an inner rail coupler and an outer rail coupler. The inner rail coupler is located in the inner longitudinal channels of the upper and lower rail portions, while the outer rail coupler is located outside of the upper and lower rail portions and aligned with the inner rail coupler. The inner and outer rail couplers are coupled via at least one fastener to couple the upper and lower rail portions together to form the multi-piece vertical rail.

According to another aspect, another of the inner rail couplers is positioned in the inner longitudinal channels at each of the upper end portion of the upper rail portion and the lower end portion of the lower rail portion. Each of the upper and lower brackets includes a rail-coupling portion. The rail-coupling portion of the upper bracket is coupled to the inner rail coupler at the upper end portion of the upper rail portion via at least one fastener to couple the upper bracket to the upper rail portion. Similarly, the rail-coupling portion of the lower bracket is coupled to the inner rail coupler at the lower end portion of the lower rail portion via at least one fastener to thereby couple the lower bracket to the lower rail portion.

According to yet another form of the present invention, a storage device is provided for containing loose articles. The storage device includes a plurality of surfaces defining a storage chamber. At least one of the surfaces is made up of a plurality of elastic cords in spaced arrangement. The elastic cords permit loose articles to pass between adjacent ones of the elastic cords so that loose articles in the storage chamber may be removed from the chamber through the at least one surface made up of elastic cords. Optionally, at least two of the surfaces may be made up of respective pluralities of the elastic cords.

According to one aspect, the elastic cords are in generally parallel arrangement.

According to another aspect, the storage device includes a pair of spaced sidewalls, with the elastic cords extending between the spaced sidewalls.

According to still another aspect, the storage device further includes at least one engaging member for releasably engaging a support rail at one of a plurality of slots in the support rail in order to support the storage device at the support rail.

Therefore, the storage device of the present invention permits reconfigurable and adaptable storage on a door, while using aesthetically-pleasing rails having concealed slots for receiving engaging members. In addition, the rails are mountable to a door at both their upper and lower portions so that the rails and storage units remain affixed to the door even when the door is set into motion or stopped from an in-motion state. Optionally, the rails may be multi-piece rails, such as to permit more compact packaging of a disassembled storage device and/or to improve the ease of handling a disassembled device. Further, the rails are mounted in such a way as not to damage the door. Optionally, the storage device is mountable at a wall or other vertical support surface with wall-mounting brackets.

These and other objects, advantages, purposes, and features of the present invention will become apparent upon review of the following description in conjunction with the drawings.

### BRIEF DESCRIPTION OF THE DRAWINGS

FIG. 1 is a perspective view of a door-supported storage device of the present invention, mounted on a door;

FIG. 2 is an exploded view of the storage device of FIG. 1, including optional wall-mount brackets;

FIG. 3 is a top plan view of a vertical rail useful with the present invention;

FIG. 4 is a front elevation of an inner rail for use with the vertical rail of FIG. 3;

FIG. 5 is a perspective view of a bracket for use with the present invention;

FIG. 6 is a perspective view of a paper storage shelf unit;

FIG. 7 is a perspective view of a multi-purpose hanger support and storage unit;

FIG. 8 is a perspective view of a basket shelf storage unit;

FIG. 9 is a perspective view of a storage shelf unit;

FIG. 10 is a perspective view of a rolled paper retainer;

FIG. 11 is another perspective view of the door-supported storage device mounted on a door, and including the rolled paper retainer of FIG. 10;

FIG. 12 is a perspective view of a slanted storage shelf unit;

FIG. 13 is a side elevation of another slanted storage shelf unit with a closable cover;

FIG. 14 is a perspective view of a storage bin having a surface made up of a plurality of elastic cords;

FIG. 15 is an exploded perspective view of a storage device in the form of a gift-wrapping station, including the storage bin of FIG. 14, and mounted on a door;

FIG. 16 is a perspective view of the storage device of FIG. 15 supported on a door;

FIG. 17 is an exploded perspective view of a storage device including five storage bins and two-piece vertical rails;

FIG. 18 is a perspective view of the storage device of FIG. 17 supported on a door;

FIG. 19 is an exploded perspective view of a storage device including seven shoe racks and two-piece vertical rails;

FIG. 20 is a perspective view of the storage device of FIG. 19 supported on a door;

FIG. 21 is an exploded perspective view of a storage device in the form of another gift-wrapping station, including two-piece vertical rails;

FIG. 22 is a perspective view of the storage device of FIG. 21 supported on a door;

FIG. 23 is an enlarged view of the section designated XXIII in FIG. 17; and

FIG. 24 is an enlarged view of the section designated XXIV in FIG. 17,

### DESCRIPTION OF THE PREFERRED EMBODIMENTS

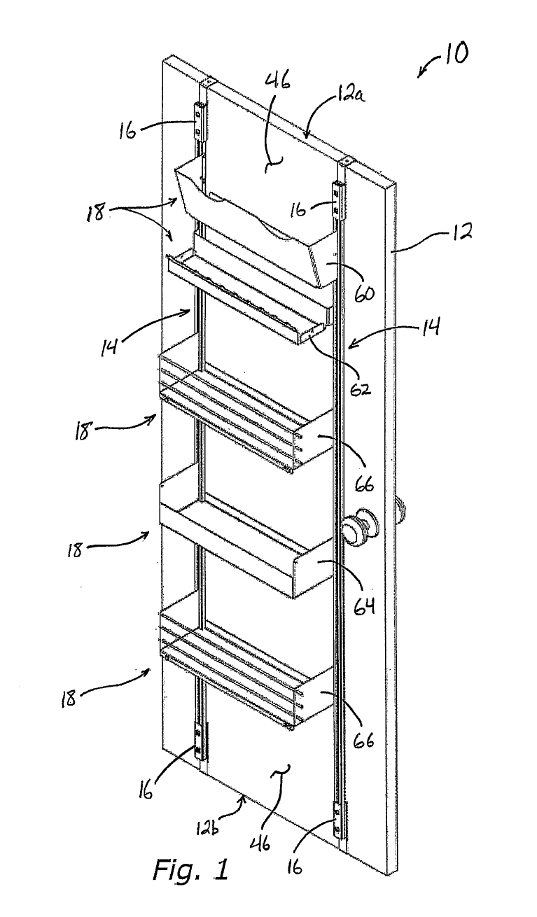

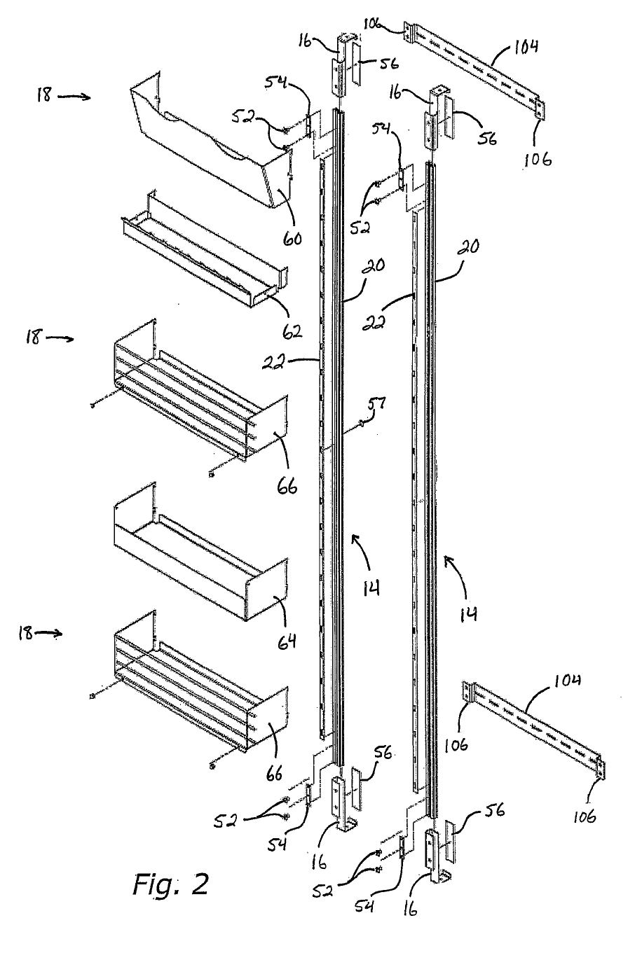

Referring now to the drawings and the illustrative embodiments depicted therein, a door-supported storage device, one preferred form of which is referenced by the numeral 10, is provided for the storage of articles, such as papers, jewelry and other small articles, mobile telephones, compact umbrellas, non-perishable food items, and substantially any other article that is desirable to store in a readily-accessible location. The storage device 10 is mountable to a door 12, such as any access door commonly found in residential, commercial, and institutional buildings (FIGS. 1 and 2). The storage device 10 includes a pair of vertical rails 14 coupled to door 12 via brackets 16. The vertical rails 14 are configured to receive one or more of a plurality of storage units 18 at various locations along the length of the rails.

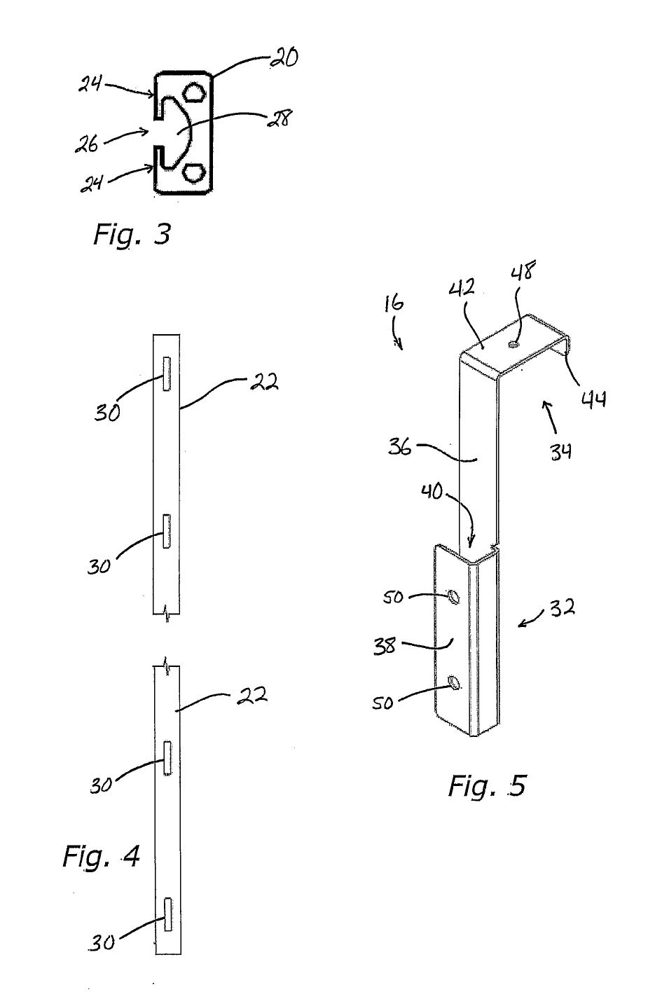

Each rail 14 has an upper end portion 14a and a lower end portion 14b, and includes an outer rail member 20 and an inner rail member 22 (FIGS. 2-4). Outer rail member 20 includes opposed front surfaces 24 defining a slot 26, and defines an inner elongate chamber or channel 28 for receiving inner rail member 22 (FIG. 3). Elongate chamber 28 and inner rail member 22 are sized so that inner rail member 22 fits in a front portion of elongate chamber 28 when the inner rail member is installed therein. Inner rail member 22 includes a plurality of slots 30 (FIG. 4) aligned in spaced vertical arrangement for receiving engaging members of storage units 18, as will be described in greater detail below. Outer rail member 20 may be molded or formed via extruding, and may be made from metal or polymeric materials, so as to provide a sufficiently strong support for inner rail 22. Inner rail member 22 may be made from any sufficiently strong material, such as sheet metal or the like. Front surfaces 24 of outer rail member 20 substantially cover and hide from view the inner rail member 22, while permitting access (between front surfaces 24 of outer rail member 20) to slots 30 of inner rail member 22.

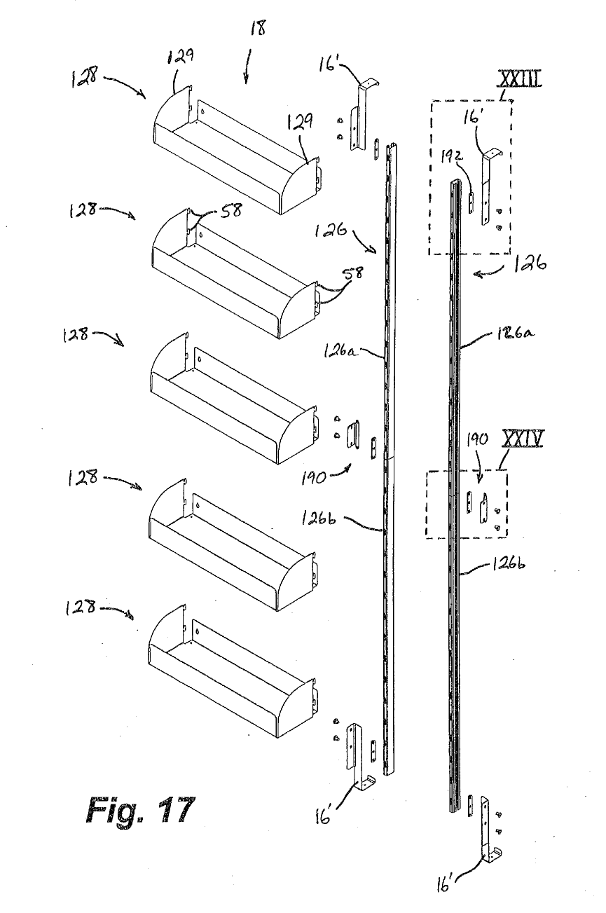

Optionally, it will be appreciated that substantially any rail having a plurality of slots or other engaging members may be used. Although shown and described as having a pair of vertical rails in horizontally-spaced arrangement, it will further be appreciated that only a single vertical rail may be used, or more than two vertical rails, or one or more horizontal rails with brackets coupling the rails to side edges of a door, without departing from the spirit and scope of the present invention. Other variations include, for example, two-piece vertical rails 126 (FIGS. 17-19 and 21-22) that may be assembled together during installation, such as will be described in greater detail below.

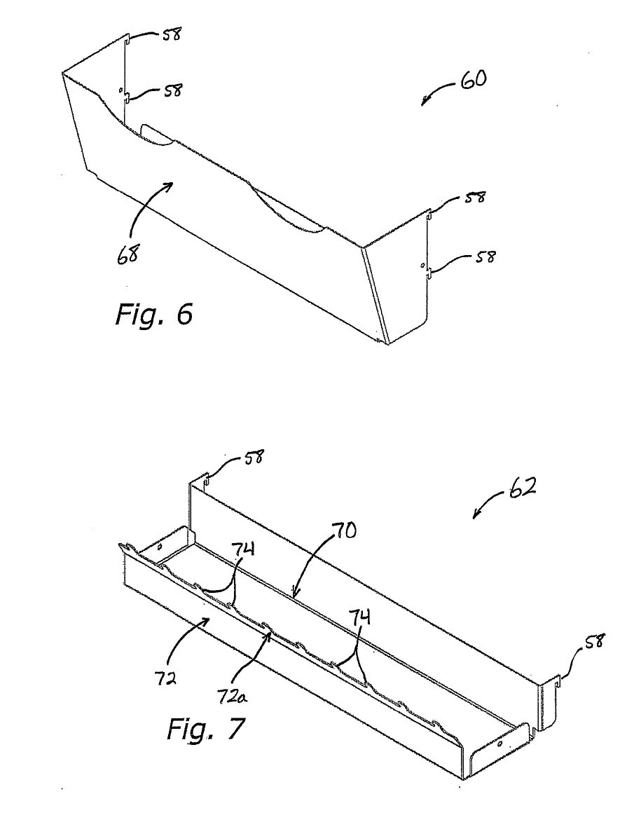

Brackets 16 include rail-coupling portions 32 and door-coupling portions 34, as best shown in FIG,. 5. Door-coupling portion 34 is joined to rail-coupling portion 32 via a flat plate member 36 that is positionable adjacent a front surface 46 (FIG. 1) of door 12. Rail-coupling portion 32 includes a generally C-shaped member 38, which defines a generally vertically-aligned channel 40 for receiving upper end portion 14a of vertical rail 14 (as shown in FIG. 5). Door-coupling portion 34 includes a horizontal element 42 for engaging or spanning across an upper edge 12a (FIG. 1) of door 12. Optionally, and as shown, door-coupling portion 34 includes a hook 44 for engaging an opposite side of door 12 near its upper edge 12a. A hole 48 in horizontal element 42 permits the optional installation of a fastener, such as a threaded screw or the like, to fixedly hold bracket 16 to door 12 by driving the fastener (not shown) into upper edge 12a of the door. C-shaped member 36 includes a pair of apertures or holes 50 for receiving fasteners 52 (FIG. 2) that engage a mounting plate 54 installed in elongate chamber 28 of outer rail member 20, to fixedly hold vertical rails 14 in channels 40 of brackets 16. A backing plate 56 (FIG. 2) is optionally provided behind upper and lower portions of vertical rails 14 to reduce the likelihood of marring or damaging front surface 46 of door 12. Optional bumpers 57 may also be positioned along rear surfaces of rails 14, between the rails and the door, to further reduce the risk of abrasion or damage to door surface 46. It will be appreciated that brackets 16 are mountable in upright orientations (FIG. 5), or inverted orientations (such as depicted at lower regions of FIGS. 1 and 2) so that the same brackets may be used at any location to hold both upper portions 14a and lower portions 14b of rails 14 to door 12.

Various different types of storage units 18 may be positioned along rails 14 by aligning engaging members 58 (FIGS. 6-10) on the storage units 18 with slots 30 of inner rail 22 according to a desired position or location of the respective storage unit 18 along rails 14. Engaging members 58 comprise downwardly-extending hook members that are sized to fit into slots 30. Engaging members 58 are coupled to inner rail number 22 by moving them downwardly after insertion to engage inner rail 22, Accordingly, storage units 18 are positionable substantially anywhere along vertical rails 14, wherever one or more slots (depending upon the number of engaging members 58 on a given storage unit 18) are open and available. Storage units 18 may be removed by initially lifting up on the storage unit and then pulling the unit horizontally away from vertical rails 14 to disengage the engaging members 58 from slots 30.

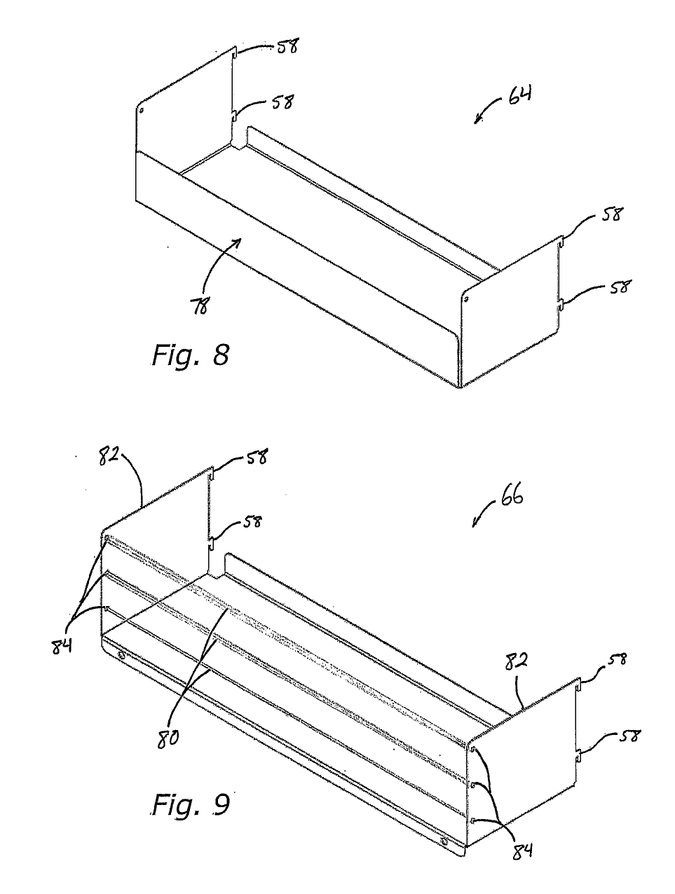

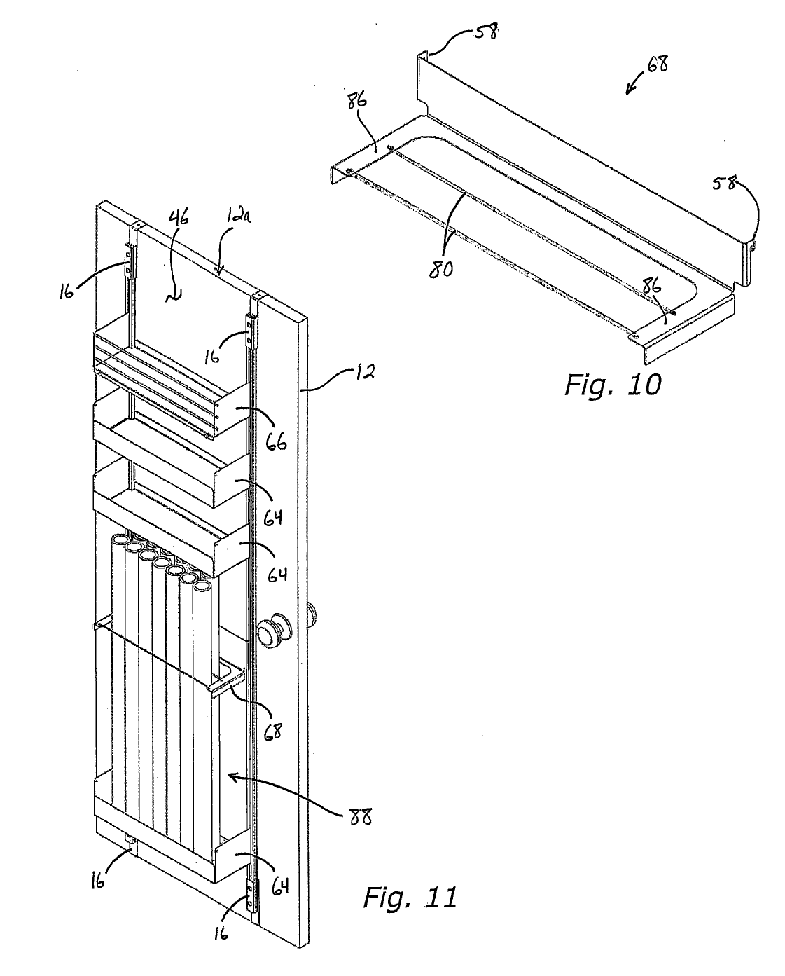

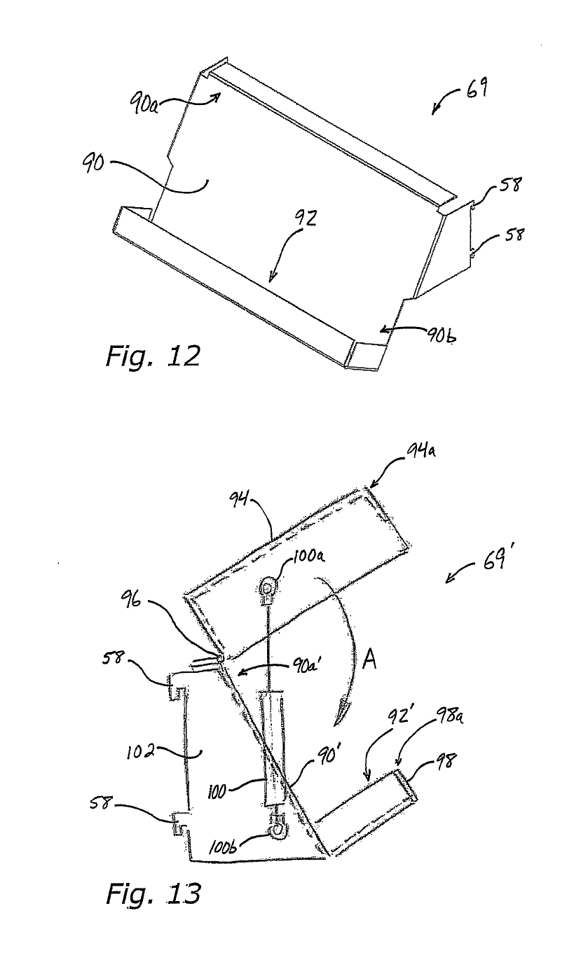

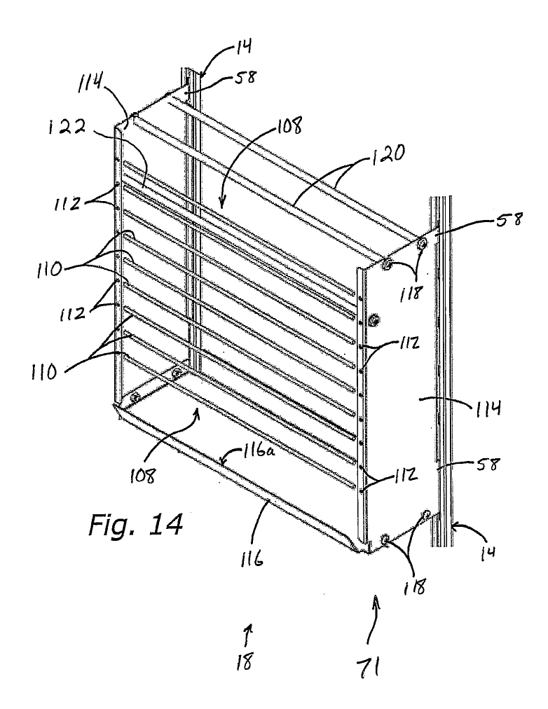

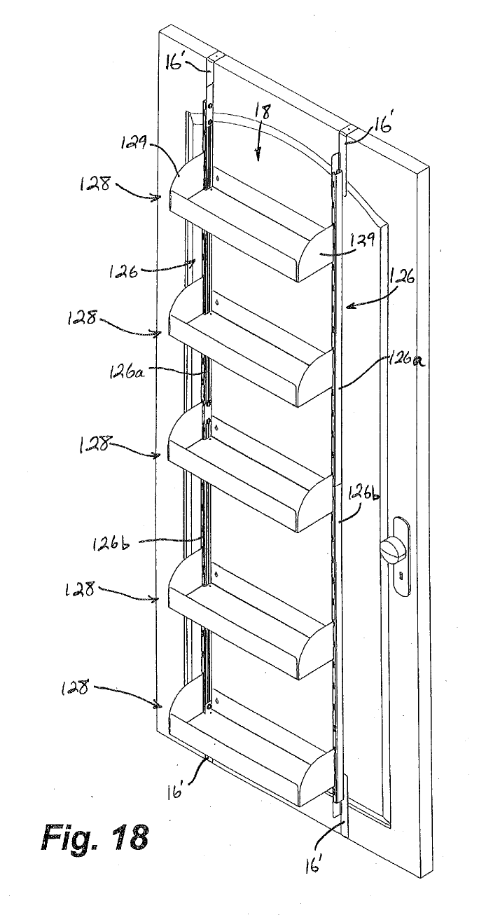

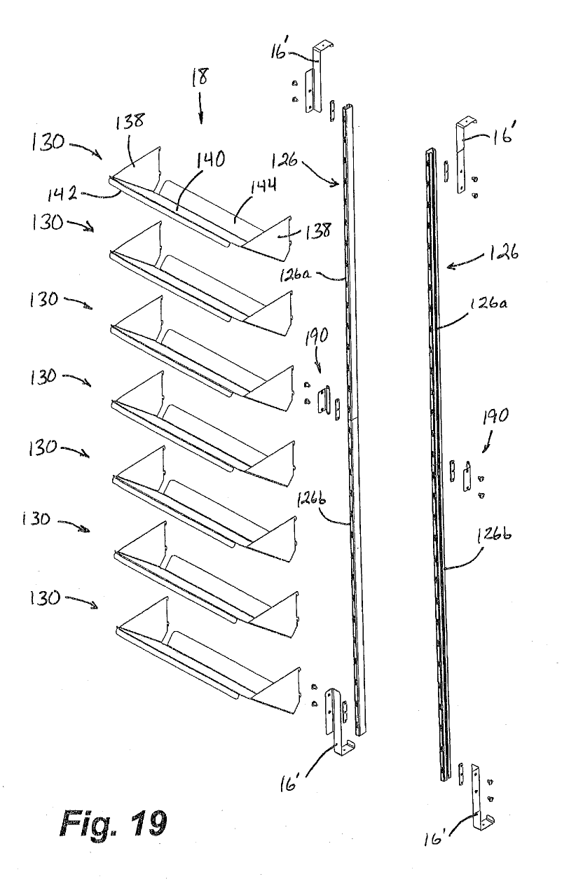

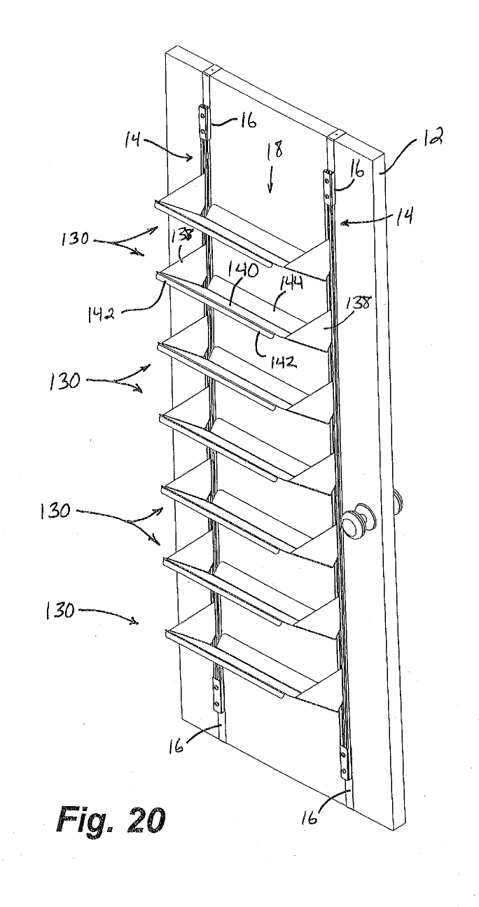

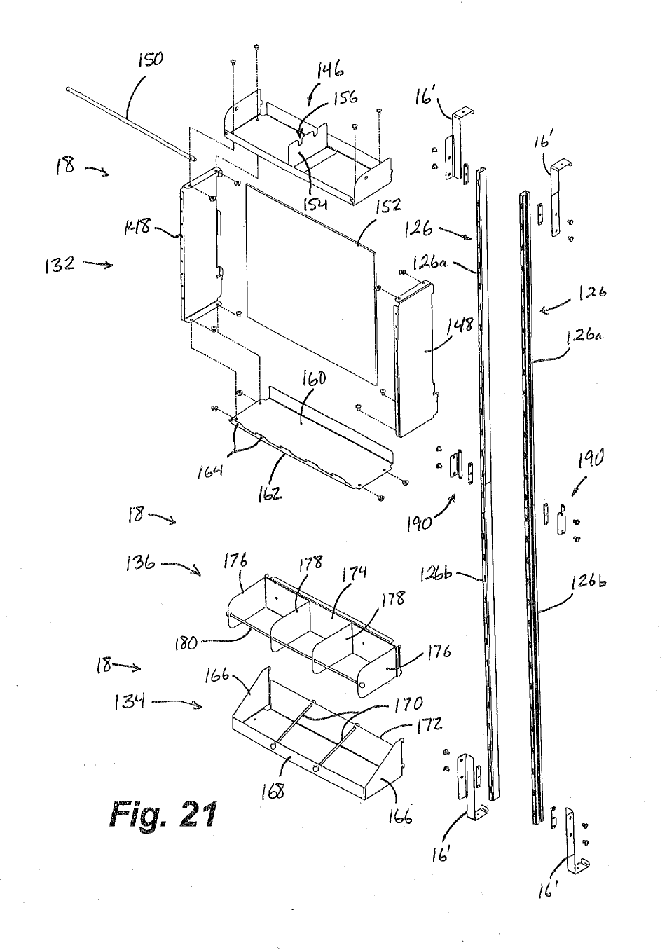

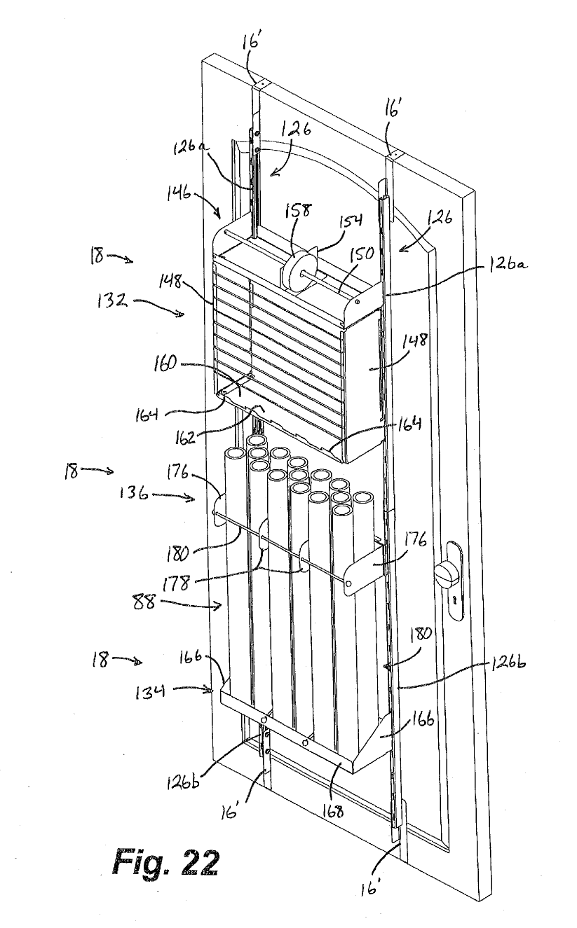

Storage units 18 include, for example, a paper shelf or bin 60 (FIG. 6), a multi-purpose hanger shelf 62 (FIG. 7) for supporting articles having hanging provisions such as straps or loops or hooks, a basket shelf 64 (FIG. 8), a storage shelf 66 (FIG. 9), a rolled paper retainer 68 (FIGS. 10 and 11), a slanted storage shelf or bin 69, 69′ (FIGS. 12 and 13), and a storage bin 71 having a wall made up of a plurality of elastic cords (FIGS. 14-16). Other storage units include, for example, another basket shelf 128 (FIGS. 17 and 18), a shoe rack 130 (FIGS. 19 and 20), and another wrapping or crafting station including a storage bin 132, a paper roll support shelf 134, and a rolled paper retainer 136 (FIGS. 21 and 22). Storage units 18 may be primarily composed of cut and formed sheet metal, for example, and may be painted or coated or finished in other manners to provide the desired appearance and surface texture.

Paper bin 60 (FIG. 6) includes a pair of engaging members 58 on either side, the engaging members spaced for engagement with respective slots 30 in rails 22. Paper bin 60 includes a front wall 70 that is angled with respect to front surface 46 of door 12 to provide an enlarged opening at the top, such as to facilitate inserting and removing papers (such as newspapers and the like) from the paper bin. Hanger shelf 62 (FIG. 7) includes a shallow tray area 72 such as for containing wristwatches, mobile phones, jewelry, billfolds, writing utensils, digital music players (e.g. MP3 players or the like), or substantially any other small articles. Basket shelf 62 includes a front wall 74 with an outwardly-flared upper region 74a having a plurality of projections 76 adapted for receiving the hook or loop or strap portions of jewelry, keys, lanyards, camera cases, small umbrellas, or any other personal items capable of hanging from a small projection.

Basket shelf 64 (FIG. 8) and storage shelf 66 (FIG. 9) each provide storage for loose articles, such as personal items, non-perishable food items, and the like. Basket shelf 64 includes a generally vertical front wall 78, while storage shelf 66 lacks a front wall but includes a plurality of bungee cords or elastic cords 80 coupled to vertical sidewalls 82 at apertures or holes 84. Elastic cords 80 permit viewing into the storage region of storage shelf 66 and facilitate access to articles stored on the storage shelf 66 by readily flexing and returning to their original positions when contacted by a user or an article on the shelf. Another basket shelf 128 (FIGS. 17 and 18) is substantially similar to basket shelf 64, described above, but has sidewalls 129 with curved top edges to provide a more aesthetically pleasing appearance.

Rolled paper retainer 68 includes a pair of spaced horizontal projections 86 having one or more elastic cords or bungee cords 80 spanning therebetween (FIGS. 10 and 11). Elastic cords 80 provide lateral support to paper rolls 88 (or any other relatively long articles) that are oriented substantially vertically and supported at their bottom ends by a basket shelf 64 (or, alternatively, by a storage shelf 66 or other suitable support) positioned below the rolled paper retainer 68, as in FIG. 11. Basket shelf 64 may be positioned a selected distance below rolled paper retainer 68 according to the height or length of rolls 88. Elastic cords 80 prevent rolls 88 from tipping or moving away from door 12, and may also be used to separate rows of rolls 88.

Slanted storage shelf or bin 69 (FIG. 12) includes a slanted or tilted back wall 90 with an upper portion 90a that is positioned closer to the rails and door than a lower portion 90b when the shelf is installed on the rails. Slanted storage shelf 69 includes a shallow tray area 92 at lower portion 90b of slanted back wall 90 for containing small articles and/or for supporting lower ends of larger articles that may extend partially out of tray area 92 and rest against slanted back wall 90. Optionally, and with reference to FIG. 13, another slanted storage shelf or bin 69′ includes a closable lid 94 pivotably coupled via a hinge 96 at or near upper portion 90a′ of its slanted back wall 90′. Lid 94 pivots about a horizontal axis at hinge 96 in a manner indicated by curved arrow A, and closes tray area 92′ when the lid is moved to its closed position. Optionally, a lock (not shown) is provided, such as at a lower edge 94a of lid 94 and at an upper edge 98a of a front wall 98 that partially defines tray area 92′, in order to lock lid 94 in its closed position and thus prevent unauthorized access to articles supported at tray area 92′.

Optionally, a lifting member 100, such as a gas-charged or spring-loaded strut or the like, includes an upper end coupler 100a coupled at lid 94 and a lower end coupler 100b coupled at a sidewall 102 of slanted storage shelf 69′. Lifting member 100 supports lid 94 in a raised position, and may urge lid 94 into its raised position from a lowered or closed position when lid 94 is not being held in the lowered or closed position. Although shown with engaging members 58, it will be appreciated that storage shelves or bins 69, 69′ may be equipped with mounting elements that permit the shelves to be more securely fastened to the rails, such as in a similar manner to that described above for coupling brackets 16 to the rails using mounting plates 54 in channel 28. Thus, slanted storage shelf or bin 69′ may be useful for secure storage of dangerous or valuable items such as, for example, firearms, ammunition, flammables, prescription drugs, jewelry, electronics, and the like.

Storage bin 71 includes a front or outer surface or wall or boundary 108 made up of a plurality of bungee or elastic cords 110 (FIG. 14). Elastic cords 110 may be substantially identical to elastic cords 80, described above. In the illustrated embodiment, elastic cords 110 are arranged horizontally and spaced vertically from one another, forming surface 108, and are spaced sufficiently from one another to permit viewing of articles contained behind surface 108 in the bin. Each cord 110 has opposite ends attached to apertures or holes 112 in opposite sidewalls 114 of the bin so that cords 110 are held at least somewhat taut and, optionally, held in parallel arrangement when bin 71 is assembled (FIGS. 14-16). Sidewalls 114 are spaced horizontally from one another and include engaging members 58 for engagement with rails 14. A bottom wall 116 is coupled along bottom edge portions of sidewalls 114 using fasteners 118, although it will be appreciated that welding or substantially any other coupling method or device may be used to join bottom wall 116 to sidewalls 114. Bottom wall 116 includes an upwardly-extending lip 116a for containing loose articles at a lower portion of the bin. A set of spacer bars, reinforcing rods, or spreaders 120 are coupled between sidewalls 114 using additional fasteners 118 at an upper portion of bin 71. Spreaders 120 support the sidewalls and substantially prevent them from bowing inwardly toward one another under loads from cords 110 when the cords are made taut (FIGS. 14 and 16). The lower ends of sidewalls 114 are further spaced and supported by bottom wall 116.

Optionally, a removable bar 122 is provided near outer surface 108, and attached between sidewalls 114, for mounting spools of materials such as ribbon, string, adhesive tape, and the like. Bar 122 may be removed from bin 71, inserted through the hubs of spools of material (such spools typically including axial center holes), and reattached to bin 71 at sidewalls 114 to permit a user to readily unspool material from any of the spools. The spools may contact one or more cords 110 in the vicinity of bar 122, in which case the cord(s) provide frictional resistance to rotation of the spools, thereby substantially preventing accidental unwinding or unspooling of materials from their respective spools.

Elastic cords 110 are flexible, stretchable, and readily spread apart from one another to facilitate access to articles stored substantially anywhere in bin 71. For example, bin 71 may be used to store ribbons and bows (such as for gift-wrapping or the like) so that a user is able to view the selection of available bows through outer surface 108 (i.e. between cords 110), and can reach between any two cords (or between a cord and another surface) by flexing or stretching the cords and grasping and pulling the desired bow or other article through the surface 108 without damaging the bow or other article. Optionally, bin 71 may be used to store other loose articles, such as when it may be desirable to select from various different articles stored in a bin without digging through the bin's contents from the top to reach a particular article located below the top layer of articles.

It will be appreciated that a storage bin having a wall made up of a plurality of elastic cords may alternatively be configured as a free-standing bin supported on a floor or other horizontal surface, or may be attached to or suspended from other surfaces. Additionally, it is envisioned that a storage bin could include two or more sides that are at least partially made up of elastic cords, with suitable support structure to hold the shape of the bin and to keep the elastic cords substantially taut, without departing from the spirit and scope of the present invention. Storage bin 71 may be combined with rolled paper retainer 68 and basket shelf 64 at a door 12 to form a wrapping or crafting station 124 (FIG. 16) that supports rolls of wrapping paper 88 at the paper retainer 68 and basket shelf 64, and bows and ribbons at storage bin 71.

Shoe rack 130 includes a pair of side walls 138, a sole-supporting plate 140, a heel plate 142, and a toe plate 144 (FIGS. 19 and 20). Sole-supporting plate 140 is angled upwardly from horizontal and extends between lower edges of side walls 138. Heel plate 142 extends downwardly from the outer end of sole-supporting plate 140, while toe plate 144 extends upwardly at an angle. For example, heel plate 142 and toe plate 144 may each extend from sole-supporting plate 140 at respective angles of about 60 degrees to 90 degrees in opposite directions from one another. Heel plate 142 may engage the heel portion of a shoe placed on shoe rack 130 to prevent the shoe from sliding down toward toe plate 144, such as for smaller heeled shoes, while toe plate 144 may engage the toe portion of a shoe to prevent the shoe from contacting and scuffing or marking the door 12, such as for larger shoes or shoes without raised heels.

Another wrapping or crafting station (FIGS. 21 and 22) includes storage bin 132, paper roll support shelf 134, and rolled paper retainer 136. Storage bin 132 is similar to storage bin 71, except that storage bin 132 lacks spreaders or spacer bars (such as spacer bars 122) and instead includes a ribbon holder bin 146 coupled between opposite side walls 148 of storage bin 132, along a top portion thereof. In addition, ribbon holder bin 146 includes a removable spool-mounting bar 150, as opposed to a bar coupled to the sidewalls, as in storage bin 71, and includes a back panel 152 between back edge portions of opposite side walls 148. Ribbon holder bin 146 includes a center support 154 with a notch 156 (FIG. 21) for supporting spool-mounting bar 150 at approximately mid-span (FIG. 22). Spool-mounting bar 150 is capable of supporting multiple spools, such as ribbon spools 158 (FIG. 22) or tape spools or the like. Storage bin 132 includes a bottom panel 160 having an outwardly-flared front wall 162 with a plurality of projections 164 for receiving the hook or loop or strap portions of ornaments, decorations, lengths of unspooled ribbon, or any other items capable of hanging from a small projection. Storage bin 132 is substantially similar to storage bin 71 in other respects, such that additional description need not be repeated.

Paper roll support shelf 134 (FIGS. 21 and 22) is similar to basket shelves 64 and 128, except that paper roll support shelf 134 includes side walls 166 with angled top edges, a reduced-height front wall 168 to facilitate lifting and removing paper rolls 88, and elastic cord dividers 170 coupled between a rear wall 172 and front wall 168. Reduced-height front wall 168 facilitates lifting and removing paper rolls 88 by minimizing the height to which paper rolls 88 must be raised for their bottom ends to clear the front wall 168. Elastic cord dividers 170 help to maintain paper rolls 88 in organized fashion, particularly when paper roll support shelf 134 is used in conjunction with rolled paper retainer 136.

Rolled paper retainer 136 (FIGS. 21 and 22) includes a back panel 174, a pair of side panels 176, a pair of intermediate divider panels 178, and a elastic cord retainer 180 for supporting and retaining upper end portions of paper rolls 88. The intermediate divider panels 178 and the side panels 176 are substantially similar to one another, with side panels 176 positioned at opposite sides of retainer 136 and divider panels 178 spaced in between, Elastic cord retainer 180 is received in through-holes at the distal end portions of each of the side panels 176 and divider panels 178. Typically, paper rolls 88 that are retained at their upper end portions between a given pair of divider panels 178 and/or side panels 176, are retained at their lower end portions between a corresponding (i.e. vertically aligned) pair of elastic cord dividers 170 and/or side panels 166 of paper roll support shelf 134 (FIG. 22). In this manner, paper rolls 88 may be arranged substantially vertically, regardless of the number of rolls supported by support shelf 134 and retainer 136.

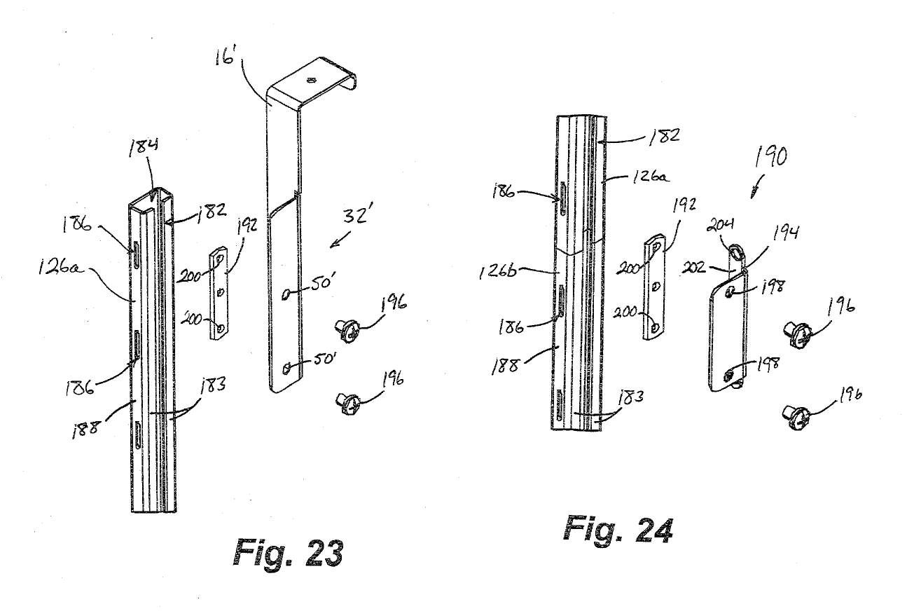

Optionally, and with reference to FIGS. 17-19 and 21-24, rails in the form of two-piece vertical rails 126 may be provided for supporting storage units 18, such as to the reduce the packaging size of a disassembled storage device of the present invention. Thus, the length of a disassembled, packaged storage device may be reduced to substantially less than the full length of the assembled vertical rails 126. In the illustrated embodiment, each two-piece rail 126 includes an upper rail portion 126a and a lower rail portion 126b, each rail portion being substantially identical to the other and arranged end-to-end to form each vertical rail 126, Each rail 126 is generally C-shaped when viewed from above, and defines an open slot 182 (FIGS. 23 and 24) in side faces 183 that, in the illustrated embodiment, are arranged to face outboard. Slot 182 is open to an inner longitudinal channel 184 that runs the length of the rail 126, while a front surface 188 defines a plurality of slots 186 that are open to channel 184, and which are aligned in spaced vertical arrangement for receiving engaging members of storage units 18.

The upper and lower rail portions 126a, 126b are joined to one another via a coupler assembly 190 (FIG. 24), which includes an inner rail coupler 192 and an outer rail coupler 194 that are coupled together via a pair of fasteners 196. Threaded portions of fasteners 196 extend through apertures or holes 198 in outer rail coupler and threadedly engage threaded apertures or holes 200 of inner rail coupler 192. During assembly of the rail portions 126a, 126b, inner rail coupler 192 is inserted into the channel 184 where the rail portions 126a, 126b about one another so that an upper portion of coupler 192 is disposed in the channel defined by upper rail portion 126a and a lower portion is disposed in the channel defined by lower rail portion 126b. Outer rail coupler 194 is then aligned with inner rail coupler 192 so that holes 198, 200 are aligned with one another and fasteners 196 are inserted and tightened in their engagement with threaded holes 200 until side faces 183 of upper and lower rail portions 126a, 126b are tightly and securely clamped between the inner rail coupler 192 and the outer rail coupler 194, Optionally, outer rail coupler 194 may include an angled portion 202 that extends behind two-piece vertical rail 126 and includes apertures or holes 204 that can receive a fastener that is driven into rail 126, or that is driven into a door or other support surface to support and/or join the upper and lower rail portions 126a, 126b.

Two-piece vertical rails 126 may be coupled to the top and bottom portions of a door using a similar method as joining the rail portions 126a, 126b, described above, Referring to FIG. 23, a bracket 16′ is similar to bracket 16, described above, except that bracket 16′ includes a rail-coupling portion 32′ with holes 50′ for receiving fasteners 196, in a similar manner as holes 198 of outer rail coupler 194, An inner rail coupler 192 is positioned inside channel 184 near an upper end of upper rail portion 126a (or near a lower end of lower rail portion 126b), and fasteners 196 are positioned through holes 50′ and tightened in threaded holes 200 of inner rail coupler 192 to clamp bracket 16′ to upper rail portion 126a (or lower rail portion 126b) at a desired location. Inner rail coupler 192 may be positioned substantially anywhere along channel 184 to align bracket 16′ with vertical rail 126 as desired. Although rails 126 are primarily described and illustrated herein as two-piece vertical rails, it will be appreciated that vertical rails having substantially any number of portions that may be coupled to one another and coupled to a door or other surface in the same manner as described above, without departing from the spirit and scope of the present invention.

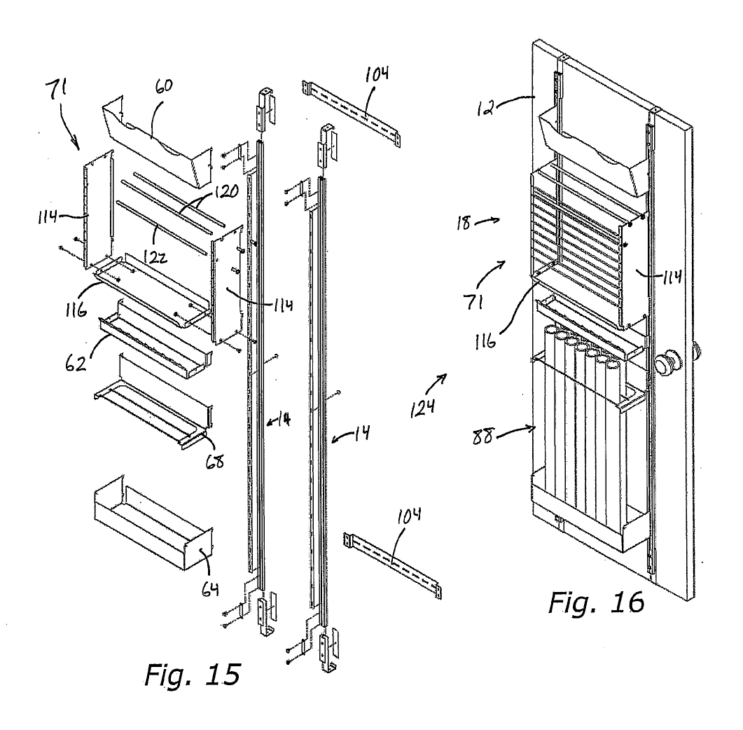

Optionally, storage device 10 may be mounted to a wall or substantially any other vertical support surface via a pair of wall-mount brackets 104 (FIGS. 2 and 15) that are fastenable to a wall or other vertical mounting surface, and which include bracket end portions 106 offset from the main body of each bracket 104. The bracket end portions 106 are fastenable to a respective upper or lower end portion of each rail 14, such as with fasteners or the like engaging mounting plates 54 positioned in channels 28 of outer rails 20, in order to mount the rails on substantially any vertical mounting surface.

Accordingly, the present invention provides a modular or adaptable and reconfigurable storage device for mounting on a door, or substantially any other vertical surface. The storage device is mountable so as not to permit the storage device to move relative to the door, which may be frequently opened and closed during use. Storage units of the device are positionable at various locations along the rails so that a user may select what type of storage unit to place at a given level or location, permitting customizable storage. In addition, the rail configuration substantially conceals the mounting features in order to provide an aesthetically pleasing mounting system. Further, the storage device may be installed and removed from a door without causing any obvious or readily-apparent damage to the door,

Changes and modifications to the specifically described embodiments may be carried out without departing from the principles of the present invention, which is intended to be limited only by the scope of the appended claims, as interpreted according to the principles of patent law including the doctrine of equivalents.

I claim:

1. A storage device for mounting on a door, said device comprising:
a vertical rail defining an inner channel, said vertical rail having an upper end portion and a lower end portion;
an inner rail disposed in said inner channel of said vertical rail, said inner rail defining a plurality of slots along a substantial portion of the length of said inner rail;
an upper bracket coupled to said vertical rail at said upper end portion, said upper bracket including a door-engaging portion for extending at least partially over and across an upper edge of the door, said upper bracket adapted to hold said upper end portion of said vertical rail against or adjacent the door;
a lower bracket coupled to said vertical rail at said lower end portion, said lower bracket including a door-engaging portion for extending at least partially under and across a lower edge of the door, said lower bracket adapted to hold said lower end portion of said vertical rail against or adjacent the door; and
an accessory for storing articles, said accessory being mountable and repositionable at a plurality of positions along said vertical rail, said accessory including an engaging member for releasably engaging said inner rail at said slots.

2. The storage device of claim 1, comprising a pair of said vertical rails including respective inner rails, said vertical rails positionable in horizontally-spaced arrangement on the door, wherein said accessory includes a pair of said engaging members in horizontally-spaced arrangement for engaging respective ones of said inner rails at said slots.

3. The storage device of claim 1, wherein said accessory comprises at least one of a paper-storage shelf, a hanger support, a basket shelf, a storage shelf for loose articles, a rolled paper retainer, a slanted storage shelf, a closable storage bin, a shoe rack, and a storage bin having at least one wall made up of a plurality of elastic cords.

4. The storage device of claim 3, wherein said accessory comprises at least two of said paper-storage shelf, said hanger support, said basket shelf, said storage shelf for loose articles, said rolled paper retainer, said slanted storage shelf, said closable storage bin, said shoe rack, and said storage bin having said at least one wall made up of a plurality of elastic cords.

5. The storage device of claim 3, wherein said accessory comprises at least one of said storage bins having said at least one wall made up of a plurality of elastic cords, said storage bin including a removable bar configured to support spools of material.

6. The storage device of claim 1, wherein said door-engaging portion of said upper bracket extends entirely across the upper edge of the door and includes a distal end portion projecting downward along a side of the door opposite the side on which said vertical rails are mounted, and wherein said door-engaging portion of said lower bracket extends entirely across the lower edge of the door and includes a distal end portion projecting upward along the side of the door opposite the side on which said vertical rails are mounted.

7. The storage device of claim 1, further comprising:
generally C-shaped portions of said upper and lower brackets, each C-shaped portion defining an open side adapted to receive a respective one of said upper end portion and said lower end portion of said vertical rail;
a fastener at each of said C-shaped portions, said fasteners adapted to couple said C-shaped portions of said upper and lower brackets to said respective ones of said upper end portion and said lower end portion of said vertical rail.

8. A storage device for mounting on a door, said device comprising:
a multi-piece vertical rail comprising at least an upper rail portion having an upper end portion and a lower rail portion having a lower end portion, said upper and lower rail portions arranged end-to-end, said upper and lower rail portions each defining an inner longitudinal channel and a plurality of slots along substantial portions of said upper and lower rail portions;
an upper bracket coupled to said upper rail portion at said upper end portion, said upper bracket including a door-engaging portion for extending at least partially over and across an upper edge of the door, said upper bracket adapted to hold said upper end portion of said upper rail portion against or adjacent the door;
a lower bracket coupled to said lower rail portion at said lower end portion, said lower bracket including a door-engaging portion for extending at least partially under and across a lower edge of the door, said lower bracket adapted to hold said lower end portion of said lower rail portion against or adjacent the door;
a rail coupler assembly engaging said upper and lower rail portions and coupling said upper rail portion to said lower rail portion; and
an accessory for storing articles, said accessory being mountable and repositionable at a plurality of positions along said multi-piece vertical rail, said accessory including an engaging member for releasably engaging said multi-piece vertical rail at said slots.

9. The storage device of claim 8, comprising a pair of said multi-piece vertical rails, said multi-piece vertical rails positionable in horizontally-spaced arrangement on the door, wherein said accessory includes a pair of said engaging members in horizontally-spaced arrangement for engaging respective ones of said multi-piece vertical rails at said slots.

10. The storage device of claim 8, wherein said accessory comprises at least one of a paper-storage shelf, a hanger support, a basket shelf, a storage shelf for loose articles, a rolled paper retainer, a slanted storage shelf, a closable storage bin, a shoe rack, and a storage bin having at least one wall made up of a plurality of elastic cords.

11. The storage device of claim 10, wherein said accessory comprises at least two of said paper-storage shelf, said hanger support, said basket shelf, said storage shelf for loose articles, said rolled paper retainer, said slanted storage shelf, said closable storage bin, said shoe rack, and said storage bin having said at least one wall made up of a plurality of elastic cords.

12. The storage device of claim 10, wherein said accessory comprises at least one of said storage bins having said at least one wall made up of a plurality of elastic cords, said storage bin including a removable bar configured to support spools of material.

13. The storage device of claim 8, wherein said door-engaging portion of said upper bracket extends entirely across the upper edge of the door and includes a distal end portion projecting downward along a side of the door opposite the side on which said multi-piece vertical rail is mounted, and wherein said door-engaging portion of said lower bracket extends entirely across the lower edge of the door and includes a distal end portion projecting upward along the side of the door opposite the side on which said multi-piece vertical rail is mounted.

14. The storage device of claim 8, further comprising:
generally C-shaped portions of said upper and lower brackets, each C-shaped member defining an open side adapted to receive a respective one of said upper end portion and said lower end portion of said multi-piece vertical rail;
a fastener at each of said C-shaped portions, said fastener adapted to couple said C-shaped portions of said upper and lower brackets to said respective ones of said upper end portion and said lower end portion of said multi-piece vertical rail.

15. The storage device of claim 8, wherein said rail coupler assembly comprises an inner rail coupler and an outer rail coupler, said inner rail coupler disposed in said inner longitudinal channels of said upper and lower rail portions and said outer rail coupler disposed outside of said upper and lower rail portions and aligned with said inner rail coupler, wherein said inner and outer rail couplers are coupled via at least one fastener to thereby couple said upper and lower rail portions together.

16. The storage device of claim 15, further comprising:
another of said inner rail couplers disposed in said inner longitudinal channels at each of said upper end portion of said upper rail portion and said lower end portion of said lower rail portion;
a rail-coupling portion at each of said upper and lower brackets; and
wherein said rail-coupling portion of said upper bracket is coupled to said inner rail coupler at said upper end portion of said upper rail portion via at least one fastener to thereby couple said upper bracket to said upper rail portion, and wherein said rail-coupling portion of said lower bracket is coupled to said inner rail coupler at said lower end portion of said lower rail portion via at least one fastener to thereby couple said lower bracket to said lower rail portion.

17. A storage device for containing loose articles, said storage device comprising:
a plurality of surfaces defining a storage chamber, at least one of said surfaces comprising a plurality of elastic cords in spaced arrangement; and
wherein said elastic cords are adapted to permit loose articles to pass between adjacent ones of said elastic cords.

18. The storage device of claim 17, wherein said elastic cords are in generally parallel arrangement.

19. The storage device of claim 17, wherein at least two of said surfaces comprise pluralities of said elastic cords.

20. The storage device of claim 17, further comprising a pair of spaced sidewalls, said elastic cords extending between said spaced sidewalls.

21. The storage device of claim 17, further comprising at least one engaging member for releasably engaging a support rail at one of a plurality of slots in the support rail, said storage device being supportable at the support rail.
